(19) United States
(12) Patent Application Publication
(10) Pub. No.: US 2006/0193973 A1
(43) Pub. Date: Aug. 31, 2006

(54) Method for treating aluminum forms

(76) Inventors: Victor Steven LaFay, Cincinnati, OH (US); Ernest William Merritt, Indian Springs, OH (US)

Correspondence Address: THOMPSON HINE L.L.P., P.O. BOX 8801, DAYTON, OH, 45401-8801, US

(21) Appl. No.: 11/353,247

(22) Filed: Feb. 13, 2006

Related U.S. Application Data
(60) Provisional application No. 60/652,173, filed on Feb. 11, 2005.

(51) Int. Cl. B05D 3/02

(52) U.S. Cl. 427/135

(57) ABSTRACT

A method for treating an aluminum form is disclosed wherein aluminum forms are contacted with a boron-containing solution to produce treated forms wherein the treated forms when used in the production of concrete structures provide surfaces having reduced defects as compared to walls produced using untreated forms. Break-in coatings or form release coatings are also disclosed for use with the treated forms.

### CROSS REFERENCE TO RELATED APPLICATION

This application claims the benefit of U.S. Provisional Application No. 60/652,173, filed Feb. 11, 2005, the contents of which are hereby incorporated by reference.

### BACKGROUND OF THE INVENTION

This invention relates to the treatment of aluminum forms used in the formulation of concrete structures. In accordance with certain aspects, the treated aluminum forms are used for installing concrete walls, and more particularly the invention relates to methods and materials for reducing concrete wall defects associated with untreated forms.

One method for forming concrete walls involves positioning forms or panels in an upright orientation so as to form a gap between forms into which the concrete will be poured to form a wall. The thickness of the gap between facing forms corresponds to the desired wall thickness. After the concrete is set the forms are typically stripped away and should release from the concrete without affecting the surface of the formed wall. Various types of forms, such as aluminum, plywood, etc. may be used in the formation of concrete walls for basements and other structures.

Aluminum forms when first used can result in defects in the poured concrete walls. Although not wishing to be bound by theory, the understanding in the art is that these defects are the result of hydrogen gas evolving as a result of contact between the fluid concrete and the surface of the aluminum forms. The defects appear as imperfections such as cracks and lines in the surface of the poured concrete.

It is well known that to increase the life of the forms and to make the removal of the forms easier, the surfaces of the form must be coated with a film forming form release coating. Coatings for the concrete industry are basically form release agents. They are used to obtain smoother surfaces with fewer defects. The poured surfaces of the concrete can erode and pit when forms are repeatedly used to produce the poured walls. When such erosion occurs, concrete has a greater tendency to adhere to the form when it is removed, affecting the poured wall surface.

### SUMMARY OF THE INVENTION

The present invention relates to a method of reducing or eliminating defects in concrete structures produced using aluminum forms. More particularly, certain embodiments of the invention relate to methods of reducing or eliminating defects in poured concrete walls by using treated aluminum forms and preventing adherence of poured surfaces to the forms by using release coatings in combination with the treated forms. In accordance with particular aspects of the invention, aluminum forms for poured concrete walls are treated using a boron-containing treatment solution. Examples of boron sources include boric acid, borax and combinations thereof. In accordance with another aspect of the invention a form release coating is applied to the form, which also reduces or eliminates defects in the poured concrete wall. Benefits of the present invention can be obtained by using treated forms, using the release coatings described herein or using both treated forms and the described release or break-in coatings.

In accordance with one aspect of the invention, the method involves applying a biodegradable vegetable oil composition to the surfaces of a form in an amount sufficient to form a coating, which prevents adherence and affords the necessary protection. The coating composition in accordance with one embodiment of the present invention relates to a biodegradable blend of vegetable oil with petroleum oil and/or alcohol and in some applications a petroleum based composition.

### BRIEF DESCRIPTION OF THE DRAWINGS

FIG. 1 is side-sectional view illustrating the manner in which concrete wall construction forms are utilized to form a concrete wall;

FIG. 2 shows a concrete wall formed in accordance with Example 1;

FIG. 3 illustrates a concrete wall formed in accordance with Example 2;

FIG. 4 illustrates a concrete wall formed in accordance with Example 3; and

FIG. 5 illustrates hydrogen defects formed in a concrete wall prepared with conventional, untreated aluminum forms.

### DETAILED DESCRIPTION OF THE INVENTION

This invention relates to an improvement of the processes for utilizing aluminum forms in the production of concrete structures. In accordance with certain aspects of the invention, the aluminum forms are treated with a treatment solution comprising boric acid, borax or a combination thereof. Another aspect of the present invention relates to the use of a break-in fluid comprising lecithin and one or more of petroleum oil and vegetable oil and after a limited number of applications of the break-in fluid can be used for future applications.

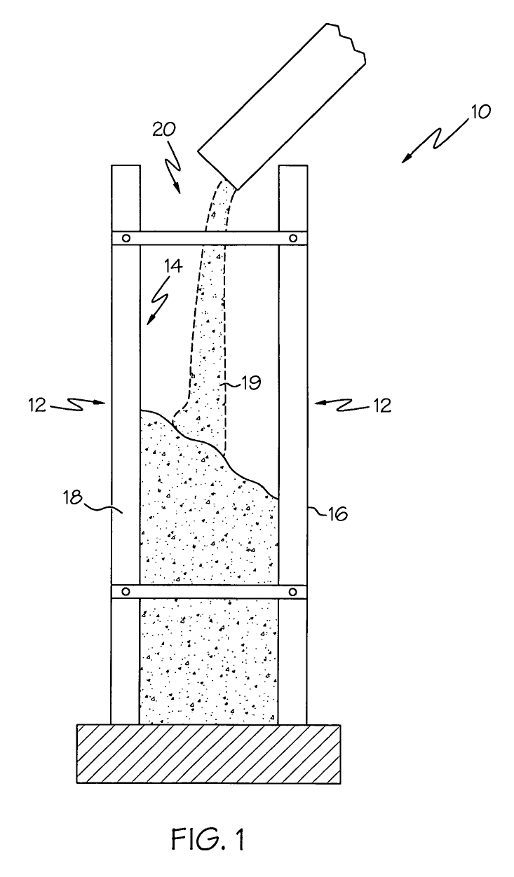

FIG. 1 illustrates a wall construction form 10 including opposing aluminum forms 12, wherein each form 12 includes a front face 14, a back 16 and edges 18. The concrete walls are formed by pouring concrete 19 into the gap 20 formed by the opposing aluminum forms 12. The front faces 14 of aluminum forms 12 are typically coated with a release agent to aid in removing the forms 12 from the hardened concrete. The concrete 19 is poured into the gap 20 and permitted to harden in a conventional fashion. When the concrete is hardened, forms 12 are stripped or removed therefrom. The release-coating composition adheres to front faces 14 and ensures that form 12 may be removed from the hardened concrete without causing defects in the surface of the wall.

The aluminum forms used in accordance with the present invention are treated before being used. The aluminum forms are treated by contacting the form with a treatment solution containing boron. In accordance with certain embodiments, the aluminum forms are treated with a treatment solution comprising borax, boric acid or combinations thereof. The treatment solution may be applied to the aluminum form by any convenient method such as by dipping the form into a solution or by spraying or brushing the solution onto the form. It is only necessary to treat the front face 14 of the aluminum form 12, as it is only the front face thereof that comes into contact with the concrete. The treated forms 12 may then be dried.

The treatment solution in accordance with the present application comprises a solution containing boron such as borax, boric acid or combinations thereof. In accordance with a specific embodiment of the invention, the treatment solution comprises a super-saturated solution containing two parts borax to one part boric acid (by weight). The supersaturated solution is heated and the aluminum forms are submerged in the supersaturated solution. The ratio of borax to boric acid is not particularly limited. For example, the ratio could vary from about all borax to about 1 part borax to 9 parts boric acid, more particularly from about 2 parts borax to 1 part boric acid to about 1 part borax to 2 parts boric acid, and still more particularly from about 2 parts borax to 1 part boric acid to about 1 part borax to 1 part boric acid. The solution need not be supersaturated, other concentrations of a boron source (borax/boric acid) may also be used provided the solution contains sufficient boron to effectively treat the surface. In accordance with certain embodiments of the present invention, the boron source may be provided at concentrations ranging from about 5% to about 50%, more particularly from about 10% to about 25%, and still more particularly from about 15% to about 20% by weight in an aqueous solution. Concentrations outside these ranges may also provide some level of treatment to the aluminum form but may require additional treatment exposure or increased temperatures. The forms will typically be treated at an elevated temperature. In accordance with a particular aspect of the invention, the treatment solution may be heated to just below the boiling point of the solution, more particularly from a temperature of about 130° F. to about 200° F., and still more particularly from about 150° F. to about 180° F.

Although the present invention has been described by reference to boric acid and borax, one of skill in the art would realize that other boron-containing compounds may also be used, such as borates and/or derivatives and mixtures thereof. Specific examples include, but are not limited to, boric oxide, B₂O₃ and other alkali metal borates, such as K₂B₄O₇·8H₂O or Li₂B₄O₇·5H₂O. Borax, Na₂B₄O₇10H₂O, is advantageous because of its relatively low cost.

The treatment solution may also include a buffer to maintain the solution within a certain pH range. Although the buffer is not particularly limited, calcium carbonate (soda ash) has been used successfully. The treatment solution will typically be maintained within a pH range of about 7.5-10, with a particularly useful operating range of about 9-9.5.

Aluminum forms treated with the above-described treatment solution provide poured-concrete walls exhibiting fewer defects in general and more particularly, exhibiting fewer hydrogen defects. Although these benefits are observed when treated forms are used in conjunction with conventional release agents, the applicants have further discovered that certain release-coating compositions provide additional improvements in the surface characteristics of the poured concrete wall.

New aluminium forms typically require the use of release coating compositions specifically designed for application during the break-in period for the new form. The break-in period may vary depending upon the construction conditions and the concrete composition. Break-in periods may extend through the first five to ten times that an aluminum form is used for forming concrete walls. In general, any of the break-in coatings conventionally used in the art can be used with the treated forms described herein.

In accordance with certain aspects of the present invention, a break-in release coating composition is used, which includes lecithin in combination with one or more of petroleum oil and vegetable oil. In accordance with this aspect of the invention, lecithin may be present in the break-in release composition at amounts up to about 90% although cost would be a consideration and lesser amounts would probably be more practical. Typically, the lecithin would be present in the break-in coating in amounts from about 2% to about 25%, more particularly from about 4% to about 12% and still more particularly from about 6% to about 8%. The remainder of the break-in coating can be based on or similar to any of the release coating compositions known to be used for this purpose.

Particularly useful release coating compositions include those described in commonly assigned U.S. Pat. No. 6,811,810, the disclosure of which is hereby incorporated herein in its entirety. The '810 patent discloses form release coatings containing a vegetable oil with petroleum oil and/or alcohol.

Vegetable oils useful in accordance with this aspect of the present invention are not particularly limited. In general, any vegetable oil may be used. Examples of vegetable oils useful include, but are not limited to, corn oil, sesame oil, rapeseed oil, sunflower oil, palm oil, olive oil, coconut oil, peanut oil, soybean oil, canola oil. Corn oil is particularly useful.

The vegetable oil may be refined or unrefined (crude). Refined oil refers to relatively pure oils in which all the fatty acids and non-oil materials have been removed by chemical means and physical or mechanical separation. Concrete form release compositions produced using unrefined vegetable oils are significantly less expensive than conventional form release compositions, which require refined petroleum or vegetable oils as a base component.

Useful alcohols include straight or branched chain alcohols having from 1 to 4 carbon atoms. Illustrative alcohols include methanol, ethanol, isopropanol, propanol, butanol, etc. Although methanol could be used as a viscosity reducer, it is not recommended because of its associated toxicity. Ethanol, particularly corn alcohol, is a particularly useful alcohol for reducing the viscosity of a corn oil.

The amount of alcohol used is the amount required to reduce the vegetable oil viscosity to the desired level. The amount of alcohol, when present, can range from about 0.5 to 10% by weight based on the total weight of the composition. Vegetable oils and alcohol are typically used at a ratio of 95 to 5, but can range from pure vegetable oil to about 90 parts vegetable oil and about 10 parts alcohol. Corn oil in combination with corn alcohol (ethanol) has been found to be particularly useful in providing a coating composition that exhibits the desired release properties and is very biodegradable.

The break-in coating may also comprise a petroleum oil blended with the vegetable oil. A blend of petroleum oil and vegetable oil is advantageous in that the vegetable oil naturally contains fatty acids. Therefore, it is not necessary to separately add fatty acids during preparation of the form coating composition to obtain desired release properties. Blends prepared in accordance with this embodiment of the invention typically contain from about 90% to about 10% vegetable oil and from about 10% to 90% petroleum oil based on the total weight of the composition.

Although fatty acids are not required to be added in the form release coating compositions, they can be added to enhance release properties. The fatty acids in accordance with the present invention include long chain fatty acids such as C₁₀-C₂₄ saturated, mono-unsaturated or di-unsaturated carboxylic acids, which are liquids at room temperature. Preferred long chain fatty acids are mono-unsaturated C₁₆-C₂₀ carboxylic acids, which are liquids at room temperature. Examples of useful fatty acids include, but are not limited to, palmitic acid, stearic acid, myristic acid, lauric acid, oleic acid, linoleic acid, and linolenic acid. A particularly useful fatty acid is oleic acid. The fatty acid portion of the formulation can range from 0 to 10% based on weight. Typical amounts of fatty acid will range from 1 to 3% by weight.

The break-in coating may also include boiled linseed oil. Typically, the linseed oil may be used in amounts up to about 10%, more particularly from about 4% to about 7%, with about 5% being particularly useful. The boiled linseed oil can also be used as a supplement or replacement for some or all of the lecithin in the break-in coating.

In accordance with particular aspects of the present invention, the break-in coating or form release coating comprises from about 40 to about 55% by weight vegetable oil, from about 40 to about 55% by weight petroleum oil and from about 2 to about 10% by weight lecithin. More particularly, the break-in composition or form release composition may comprise from about 45 to 50% by weight vegetable oil, from about 45 to 50% by weight petroleum oil and from about 5 to about 10% lecithin. Formulations containing corn oil and mineral seal oil in addition to the lecithin are particularly useful.

The break-in coating compositions or concrete form release compositions may be applied to solid surfaces of the form in contact with fresh concrete by means such as brushing, rolling or spraying. For most large scale applications spraying is the most common method of application. The coating compositions can be applied to the treated forms either before or after the forms are placed upright and positioned to form walls.

The form release coating composition of the present invention is applied in an amount sufficient to provide the desired release properties from the form. Typically, this will correspond to a coating thickness of from about 2 to about 10 mils. In accordance with particular embodiments of the present invention, the coating is applied at a coating thickness of from about 6 to 8 mils. Of course, additional material can be applied to provide the desired release.

Some of the form release coating compositions described herein and in the '810 patent are advantageous in that they are biodegradable. Vegetable oils and alcohols are highly degradable, particularly under aerobic conditions. Accordingly, although the present invention can be used in conjunction with any types of release compositions, the biodegradable form release compositions are more environmentally friendly than the petroleum hydrocarbon based compositions.

Having given the teachings of this invention, it will now be illustrated by means of specific examples that are representative of the invention and should not be considered as limiting in any way.

### EXAMPLE 1

A treating solution can be prepared by adding about 800 pounds borax and about 400 pounds boric acid to a tank containing approximately 700 gallons water to form a supersaturated solution. The solution is heated to about 170° F. and new aluminum forms are submerged in the solution for approximately 30 to 45 minutes such that the entire form is exposed to the solution. The treated forms are allowed to dry and then are ready to be used in the production of concrete walls.

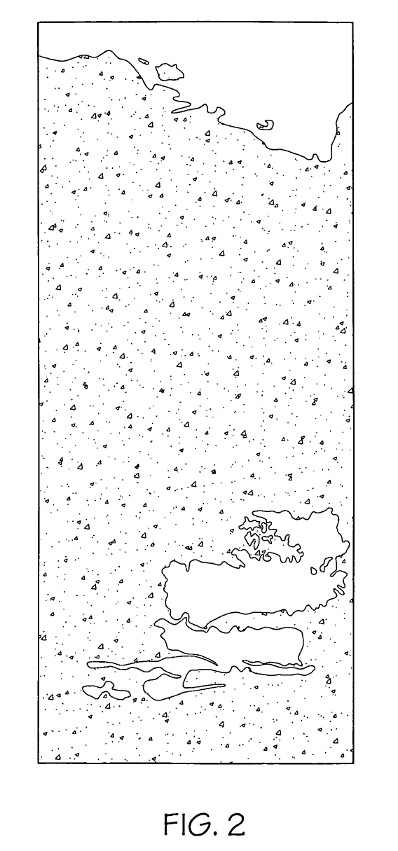

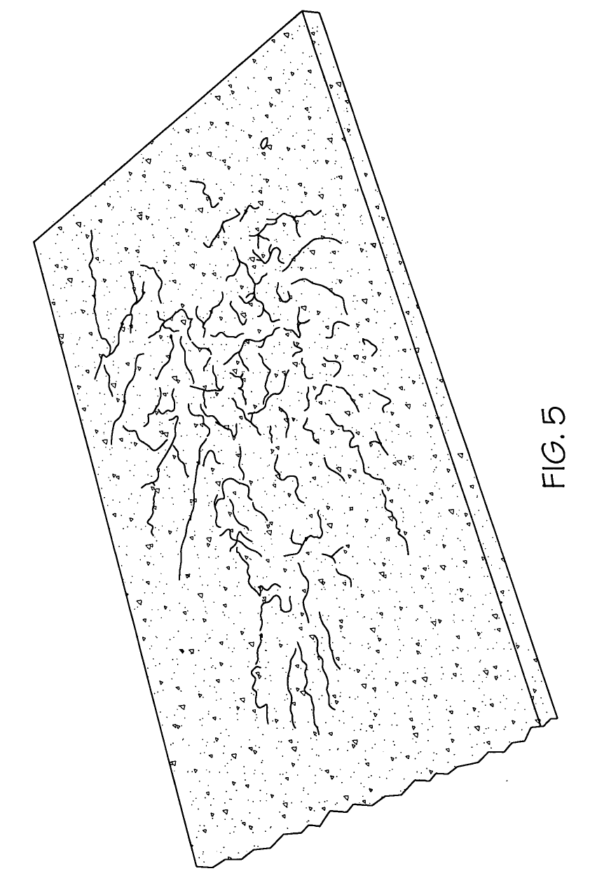

The treated forms are coated with the following break-in coating (Formulation A) applied by a conventional spray applicator to the front face of the forms. The forms are placed in an upright position corresponding to the location for the concrete wall and secured in a conventional manner. Concrete is poured into the gap between opposing forms such that the wet concrete comes into contact with the front face of each form. The concrete is allowed to harden and the forms are removed from the poured concrete wall. The wall surface was examined to identify hydrogen defects. As seen in FIG. 2 the surface of the concrete wall has noticeably fewer defects that the wall prepared in accordance with the conventional untreated aluminum forms shown in FIG. 5.

FORMULATION A

| MATERIAL | PARTS BY WEIGHT |
|---|---|
| Corn oil | 46.5 |
| Mineral seal oil | 46.5 |
| Lecithin | 7 |

### EXAMPLE 2

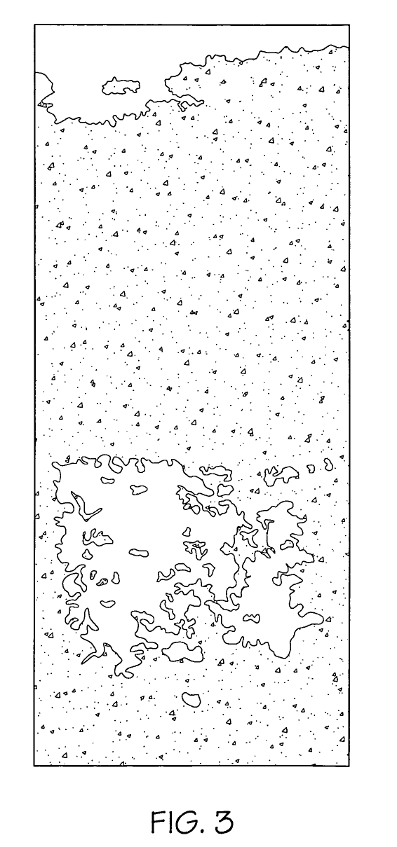

The procedure in Example 1 was followed except that the following break-in coating (Formulation B) was applied to the forms. Again the surface of the resulting concrete wall as shown in FIG. 3 has noticeably fewer defects that the wall prepared in accordance with the conventional untreated aluminum forms shown in FIG. 5.

FORMULATION B

| MATERIAL | PARTS BY WEIGHT |
|---|---|
| Corn oil | 47.5 |
| Mineral seal oil | 47.5 |
| Lecithin | 5 |

### EXAMPLE 3

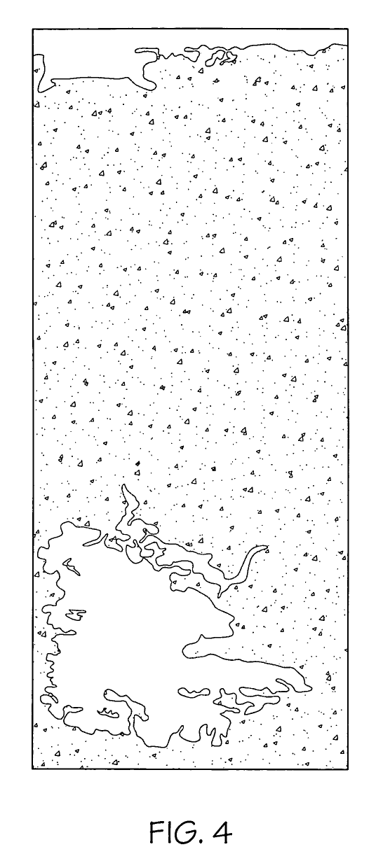

The procedure in Example 1 was followed except that the following break-in coating (Formulation C) was applied to the forms. The surface of the resulting concrete wall as shown in FIG. 4 has noticeably fewer defects that the wall prepared in accordance with the conventional untreated aluminum forms shown in FIG. 5.

FORMULATION C

| MATERIAL | PARTS BY WEIGHT |
|---|---|
| Mineral seal oil | 99.5 |
| Lecithin | 0.5 |

Various modifications are possible within the spirit of this invention as will be obvious to those skilled in the art. Such variations are deemed to be within the scope of this invention.

What is claimed is:

1. A method for treating an aluminum form comprising:
providing an aluminum form having a first surface;
contacting at least the first surface of the aluminum form with a boron-containing solution to produce a treated form; and
subsequently applying a form release coating composition to the first surface of the treated form in an amount sufficient to form a coating thereon wherein the treated form when used in the production of poured concrete walls is capable of producing walls having reduced defects as compared to walls produced using an untreated form.

2. The method of claim 1, wherein said step of contacting an aluminum form with a boron-containing solution comprises dipping the aluminum form in the boron-containing solution.

3. The method of claim 1, wherein said step of contacting an aluminum form with a boron-containing solution comprises spraying or brushing the boron-containing solution onto the first surface of the form.

4. The method of claim 1, wherein said aluminum form is contacted with a boron-containing solution wherein the solution is at a temperature within the range of about 130° F. to about 200° F.

5. The method of claim 1, wherein the boron-containing solution comprises a boron source selected from the group consisting of boric acid, borates, derivatives thereof and mixtures thereof.

6. The method of claim 5, wherein said boron-containing solution comprises boric acid, borax or combinations thereof.

7. The method of claim 6, wherein the boron-containing solution comprises a mixture of borax and boric acid within a range of from about 1 part borax to 9 parts boric acid to about 2 parts borax to 1 part boric acid.

8. The method of claim 6, wherein the boron-containing solution comprises a super-saturated solution comprising borax, boric acid or a combination thereof.

9. The method of claim 8, wherein the contacting step comprises contacting the aluminum form with the super-saturated solution at a temperature from about 150° F. to about 180° F.

10. The method of claim 1, wherein the coating composition comprises lecithin, boiled linseed oil or mixtures thereof.

11. The method of claim 10, wherein the coating composition further comprises vegetable oil.

12. The method of claim 1, wherein the coating composition further comprises a viscosity reducer.

13. The method of claim 12, wherein the viscosity reducer is selected from the group consisting of mineral seal oil, alcohol and mixtures thereof.

14. The method of claim 1, wherein the coating composition further comprises vegetable oil and a viscosity reducer selected from the group consisting of mineral seal oil, alcohol and mixtures thereof.

15. A method for forming a concrete structure comprising:
providing an aluminum form having a front face;
treating at least the front face of the aluminum form by contacting the front face with a boron-containing solution;
subsequently applying a form release coating composition to at least the front face of the aluminum form;
contacting the front face of the aluminum form with concrete;
allowing the concrete to harden into a formed structure; and
removing the aluminum form from the formed structure.

16. The method of claim 15, wherein said step of treating the aluminum form with a boron-containing solution comprises dipping the aluminum form in the boron-containing solution.

17. The method of claim 15, wherein said step of treating the aluminum form with a boron-containing solution comprises spraying or brushing the boron-containing solution onto the form.

18. The method of claim 15, wherein said aluminum form is contacted with a boron-containing solution at a temperature within the range of about 130° F. to about 200° F.

19. The method of claim 15, wherein the boron-containing solution comprises a boron source selected from the group consisting of boric acid, borates, derivatives thereof and mixtures thereof.

20. The method of claim 19, wherein said boron-containing solution comprises boric acid, borax or combinations thereof.

21. The method of claim 20, wherein the boron-containing solution comprises a mixture of borax and boric acid ranging form about 1 part borax to 9 parts boric acid to about 2 parts borax to 1 part boric acid.

22. The method of claim 20, wherein the boron-containing solution comprises a super-saturated solution comprising borax, boric acid or a combination thereof.

23. The method of claim 22, wherein the super-saturated solution is at a temperature from about 150° F. to about 180° F. when contacting the aluminum form.

24. The method of claim 15, wherein the coating composition comprises lecithin, boiled linseed oil or mixtures thereof.

25. The method of claim 24, wherein the coating composition further comprises vegetable oil.

26. The method of claim 15, wherein the coating composition further comprises a viscosity reducer.

27. The method of claim 26, wherein the viscosity reducer is selected from the group consisting of mineral seal oil, alcohol and mixtures thereof.

28. The method of claim 15, wherein the coating composition further comprises vegetable oil and a viscosity reducer selected from the group consisting of mineral seal oil, alcohol and mixtures thereof.

29. A method for forming a concrete wall comprising:
providing at least two aluminum forms, each having a front face;
treating at least the front face of each aluminum form by contacting the front face with a boron-containing solution;
subsequently applying a form release coating composition to at least the front face of each of the aluminum forms;
positioning the aluminum forms to create a gap between opposing faces of the forms;
pouring concrete into the gap thereby contacting the front face of each of the aluminum forms with concrete;
allowing the concrete to harden into a formed wall; and
removing the aluminum form from the formed wall.
